(19) United States
(12) Patent Application Publication
(10) Pub. No.: US 2014/0331696 A1
(43) Pub. Date: Nov. 13, 2014

(54) METHODS AND SYSTEMS FOR MINIMIZATION OF MECHANICAL EFFECTS OF IMPACT VELOCITY DURING TISSUE PRESERVATION

(71) Applicant: Northeastern University, Boston, MA (US)

(72) Inventors: Nector Ritzakis, Brookline, MA (US); Jeffrey W. Ruberti, Lexington, MA (US)

(73) Assignee: NORTHEASTERN UNIVERSITY, Boston, MA (US)

(21) Appl. No.: 14/364,840

(22) PCT Filed: Dec. 17, 2012
(86) PCT No.: PCT/US12/70209

§ 371 Date: Jun. 12, 2014

Related U.S. Application Data
(60) Provisional application No. 61/576,696, filed on Dec. 16, 2011.
(60) Provisional application No. 61/579,292, filed on Dec. 22, 2011.

(51) Int. Cl. G01N 1/30; F25D 31/00

(52) U.S. Cl. CPC G01N 1/30; F25D 31/00
USPC 62/62; 427/2.11

(57) ABSTRACT

Disclosed herein are methods and devices for preserving a sample for histological analysis, in particular embodiments, the disclosed methods and devices allow for contacting a surface with the sample at a contact velocity of between 0.05 cm/s to 10 cm/s.

This application claims the benefit of prior i of U.S. Provisional Application Ser. No. 61/576,696, filed Dec. 16, 2011 and U.S. Provisional Application Ser. No. 61/579,292, filed Dec. 22, 2011, the specifications of which are incorporated by reference in their entirety.

### FIELD OF THE INVENTION

The invention is generally directed to medicine and research. More specifically, the invention is directed to the analysis of samples such as tissues by electronic microscopy and other visualization technologies.

### BACKGROUND

In the field of electron microscopy sample preparation, slam freezing on a cooled metal mirror has been considered a relative gold standard that provides nearly artifact-free preservation of a tissue or even isolation of a dynamic event (see, e.g., Heuser, J. E., T. S. Reese, and D. M. Landis, Cold Spring Harb Symp Quant Biol, 40:17-24 (1976)). This technique involves the rapid contact (i.e., “slamming”) of a sample of interest onto an extremely cold surface (e.g., generally below 150 Kelvin). The high fidelity of the preservation is thought to be due to the rapidity of the freezing wave which, over short distances at the sample surface may approach the speed of the mechanical deformation wave (see id.). In addition, certain researchers have hypothesized that this technique avoids sample damage relating to “pre-cooling” of tissues in cold nitrogen vapors that exist just above the frozen substrate by not allowing the sample to remain in the cold vapors for a sufficient period of time to allow tissue cooling (see Memo, B. P. M., Journal of Electron Microscopy Technique, 4(3): p. 177-240 (1986)).

With the advantages associated with slam freezing, this technique has become one of the preferred tissue preservation techniques used by researchers. Slam freezing devices are widely-available and a variety of techniques have been developed using such devices (see, e.g., Boyne, A. F., J Neurosci Methods, 1(4):353-64 (1979); Gilkey, J. C. and L. A. Staehelin, Journal of Electron Microscopy Technique, 3(2):177-210 (1986); Allison, D. P., C. S. Daw, and M. C. Rorvik, J Microsc, 147(Pt 1):103-8 (1987); Health I. B., J Microsc, 135(Pt 1):75-82(1984)).

However, the inventors of the disclosed methods and devices have discovered that samples prepared by the standard “slam freezing” technique do indeed suffer substantial deformation and distortion. It appears that the sample does not freeze fast enough to prevent severe mechanical stress to the tissue due to the slamming of the tissue. The inventors discovery establishes that tissues preserved by standard slam freezing techniques and devices must not give a fully accurate snapshot of the cells and tissues at the time that they are frozen.

Therefore, there remains a need to provide methods and systems that preserve tissues with reduced disruption due to the preservation process. Such methods and systems would decrease the likelihood of artifacts caused by mechanical deformation of tissues. In turn, such methods and systems would provide a more accurate view of cells and tissues when studied by researchers using visualization techniques such as electron microscopy,

### SUMMARY

Disclosed are methods and devices for the preservation of samples (e.g., tissue or cell samples) for visualization. The disclosed methods and devices allow for contacting a surface with a sample at a specified range of velocities which are known to minimize mechanical deformation of the sample. The disclosed methods and devices accomplish low velocity contact of the sample to the surface without unduly increasing the amount of time that the sample remains on a positioner. As disclosed herein, low velocity contact of the sample to the surface is accomplished by actuating the positioner toward the surface such that the positioner will approach the surface at a certain velocity. As the positioner approaches the surface, the positioner is decelerated such that the sample contacts the surface at a low velocity.

In some embodiments disclosed herein, the positioner continuously decelerates from a starting velocity as it approaches the surface. In other embodiments, the positioner decelerates in stages from a first velocity. For instance, the disclosed methods and devices allow for a “two-phase” approach to the surface. In such embodiments, the presently disclosed methods and devices provide for a “fast approach” phase in which the device accelerates the sample to a relatively high velocity to reduce the time that the sample is on the positioner. The methods and devices further provide for a “slow contact” second phase in which the device decelerates the sample so that the sample contacts the surface at a much reduced velocity to prevent mechanical deformation of the sample. Furthermore, the presently disclosed methods and devices can allow for multiple phases (e.g., three or more) in which the positioner is alternatively accelerated or decelerated toward the surface depending on the calculated position of the positioner on a guide. The disclosed methods and devices further allow for minimizing the lime the sample spends on the positioner, while reducing contact velocity. Accordingly, the methods and devices disclosed herein represent a substantial advance over past slam freezing devices and techniques.

Aspects of the methods disclosed herein relate to attaching a sample to a surface. The methods comprise contacting the sample to the surface at a contact velocity of 0.05 cm/s to 10 cm/s, wherein the sample is affixed to a first end of a positioner and wherein the sample freezes after contacting the surface.

In certain embodiments, the positioner is normal to the surface. In the other embodiments, the methods further comprise actuating the positioner to a first velocity. In still other embodiments, the methods further comprise decelerating the positioner to the contact velocity from the first velocity.

In certain embodiments, the first velocity is a maximum velocity of about 4.5 In some embodiments, the positioner is continuously decelerated after the positioner reaches the first velocity. In particular embodiments, the positioner is movably attached to a guide and the positioner is decelerated upon reaching a first position on the guide.

Aspects of the disclosed methods include affixing a sample to a surface. The methods comprise attaching the sample to a first end of a positioner and accelerating the positioner to a first velocity toward the surface. The methods also entail decelerating the positioner to a contact velocity before the sample contacts the surface. In particular aspects, the methods comprise contacting the surface with the sample at the contact velocity, wherein the sample contacts the surface less than or equal to 0.3 seconds after the positioner is accelerated toward the surface.

In certain embodiments, the first velocity is a maximum velocity of at least 1.0 m/s. In other embodiments, the contact velocity is 0.05 to 10 cm/s.

In certain embodiments, the positioner is normal to the surface. In some embodiments, the positioner is movably attached to a guide. In particular embodiments, the sample is attached to a solid support that is affixed to the first end of the positioner.

Additional aspects disclosed herein relate to methods of attaching a sample to a surface. In these aspects, the methods comprise affixing a solid support to a first end of a positioner movably attached to a guide such that the positioner is normal to a surface, and wherein the sample is attached to the solid support. The methods further entail actuating the positioner toward a first location on the guide, the positioner attaining a first velocity and decelerating the positioner subsequent to the positioner reaching the locution on the guide such that the positioner attains a contact velocity of 0.05 cm/s to 10 cm/s prior to the sample contacting the surface. The methods also comprise contacting the surface with the sample after the positioner has attained the contact velocity.

Some embodiments of the aspects disclosed herein include surfaces comprising copper, steel, aluminum, gold, silver, sapphire, or diamond. Some embodiments also include a solid support comprising ceramic or metal. Any surface with a thermal conductivity in excess of 100 W/m K° at LN2 boiling temperature (approx. 77 K.°).

In certain embodiments, the positioner is a linear motor actuator. In other embodiments, the positioner is magnetized. In still other embodiments, the positioner is removably attached to the guide. In further embodiments, the location on the guide defines a total distance from the sample to the surface. In still further embodiments, the total distance is divided into at least a first distance and a final distance from the sample to the surface. In other embodiments, the positioner travels the final distance to the surface in a total time of less than or equal to 0.1 seconds.

Some embodiments further comprise accelerating the positioner subsequent to the first end of the positioner reaching the first location on the guide so that the positioner attains the first velocity after the first end of the positioner reaches the location. Other embodiments relate to methods further comprising determining that the positioner has reached a second location. Some embodiment; relate to methods further comprising determining the time point that the sample will reach a second location on the guide based on the determination that the sample reached the first location, wherein the positioner is decelerated upon reaching the second location

In certain embodiments, the positioner is decelerated at the second location on the guide. In particular embodiments, the position of the sample is determined by a sensor. In further embodiments, the sensor comprises a sheet laser. In some embodiments, the sample is a tissue.

Certain embodiments relate to methods further comprising determining the first velocity to which the positioner will be accelerated. Still further embodiments relate to methods further comprising determining the contact velocity to which the positioner will be decelerated and/or methods further comprising storing the determined first velocity and determined contact velocity in a memory.

In some embodiments, the solid support is attached to a magnetic mount. In other embodiments, the magnetic mount is further attached to the first end of the positioner.

In still other embodiments, the first velocity is at least 1.0 m/s. In particular embodiments, the first velocity is about 4.5 m/s.

In certain embodiments, the contact velocity is 0.1 to 10.0 cm/s. In particular embodiments, the contact velocity is 5.0 to 7.5 cm/s. In more particular embodiments, the contact velocity is 2.5 to 5.0 cm/s. In more particular embodiments, the contact velocity is about 2.5 cm/s.

In some embodiments, the positioner is accelerated at 100 m/s² to attain the first velocity. In other embodiments, the positioner is accelerated at greater than or equal to 100 m/s² to attain the first velocity. In still other embodiments, the positioner is decelerated at greater than or equal to 100 m/s² to attain the contact velocity after reaching a location on the guide, wherein the location on the guide is either the first location or a different location. In More embodiments, the positioner is decelerated at greater than or equal to 50 m/s² or greater than or equal to 20 m/s² to attain the contact velocity after reaching a location on the guide, wherein the location on the guide is either the first location or a different location. In particular embodiments, the positioner is decelerated at 150 m/s² after reaching the location on the guide to attain the contact velocity. In some embodiments, the sample freezes after contacting the surface.

Some embodiments relate to methods further comprising providing a computer having a memory, the memory providing code to at least one processor such that the processor controls the positioner to attain the first velocity and the contact velocity based on a determined first and contact velocity stored in the memory.

### DESCRIPTION OF THE FIGURES

The following figures are presented for the purpose of illustration only, and are not intended to be limiting:

FIG. 1 shows an embodiment of a slam freezer device.

FIG. 2 is a diagrammatic representation showing how the slam freezing device works to generate a “two-phase” approach to the surface. In particular, X_{M} is the distance from the loading position of the motorized actuator to the surface shown in the embodiment of FIG. 1. X_{L} relates to the distance from the loading position of the motorized actuator to the sensor of the embodiment of FIG. 1. X_{LM} is the distance from the sensor to the surface. D₁ and D₂ relate to the distance of the first “fast approach” phase of the motorized actuator and the distance of the second “slow contact” phase of the motorized actuator, respectively.

FIG. 3a is a graphical representation showing the “two-phase” approach. The graph shows the velocity of the sample (m's) as a function of time (seconds). The velocity of the sample is shown to peak at 4.5 m/s and decline to 10 cm/s at 0.08 seconds.

FIG. 3b is a graphical representation showing only the second phase The graph shows the velocity of the sample (m/s) as a function of time (seconds).

FIG. 4 is a schematic of a sample holder used to prepare samples for slam freezing.

FIG. 5a is a representation showing the components of the sample holder in exploded view.

FIG. 5b is a drawing of the entire sample holder.

FIG. 6 is a diagrammatic representation of the first end of the positioner (in this embodiment, a motorized actuator) and the sample placed on the first end.

FIG. 7 is a diagrammatic representation of a strain measurement method in a polar coordinate system. FIG. 7a shows three correlated beads before (x) and after (x′) a freezing event. To estimate the effect of freezing, the distance and angles between each bead pair is measured before and after freezing. FIG. 7b shows the coordinate system where X, Y plane was parallel to the mirror surface, while increasing Z is increasing depth into the sample.

FIG. 8a shows the overlaid velocity profiles of second phase studies for velocities of 2.5 cm/s, 5.0 cm/s, 10.0 cm/s, and 30 cm/s.

FIG. 8b shows the overlaid velocity profiles of second phase studies for velocities of 2.5 can/s, 5.0 cm/s, and 10.0 cm/s.

FIG. 9 shows qualitative evidence of distortion increasing with increasing impact speed. The images are arranged from top to bottom: Row 1 shows control (two phase approach executed with no impact), Row 2 shows 2.5 cm's second phase velocity, Row 3 shows 5.0 cm's second phase velocity, Row 4 shows 10.0 cm/s second phase velocity, and Row 5 shows 30 cm/s second phase velocity. From left to right, Column a shows pre-freezing DIC optical micrograph of the surface of the sample showing the glass rod fiduciary markers and embedded microspheres (small black dots), Column b shows post-freezing DIC optical micrograph of the sample surface, and Column c shows data of extracted positions of correlated bead populations. The black dots represent the pre-freezing positions and the white dots represent the post-freezing bead positions.

FIG. 10a is a graphical representation of deformation results of sample contacting a surface at different second velocities. FIG. 10a plots average stretch ratio versus impact velocity (cm/s).

FIG. 10b is a graphical representation of deformation results of sample contacting a surface at different second velocities. FIG. 10b plots average change in theta (projected angle in the x-y plane as a function of impact velocity (cm/s).

FIG. 10c is a graphical representation of deformation results of sample contacting a surface at different second velocities, FIG. 10c plots average change in phi (declination angle from x-y plane as a function of impact velocity (cm/s).

FIG. 11 shows the numerically calculated temperature profiles for the sample surface during the approach to the cooled mirror. The 1-D nodal analysis shows the sample center surface temperature for three two-phase approach profiles and for a single phase rapid approach (solid lines).

FIG. 12 shows an example of X-Y projection plot of heads found in top 30 microns of sample.

FIG. 13 shows a verification that the algorithm (squares plot) for calculating frame of focused head is equivalent to human manually finding focused bead (diamonds plot).

FIG. 14 shows the results of a test sample frozen at impact velocities greater than 30 cm/s. The glass fiber pattern in the test sample is greatly distorted after freezing (h) when compared to pre-frozen pattern (a). Closer observation could not yield adequate bead correlations. Magnification: 20×. Scale bar: 30 microns

### DETAILED DESCRIPTION

All publications, patent applications, patents, and other references mentioned herein are incorporated by reference in their entirety. In case of conflict, the present specification, including definitions, will control. In addition, the materials, methods, and examples are illustrative only and not intended to be limiting.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below.

### 1. DEFINITIONS

For convenience, certain terms employed in the specification, examples and claims are collected here. Unless defined otherwise, all technical and scientific terms used in this disclosure have the same meanings as commonly understood by one of ordinary skill in the art to which this disclosure belongs. The initial definition provided for a group or term provided in this disclosure applies to that group or term throughout the present disclosure individually or as part of another group, unless otherwise indicated.

The articles “a” and “an” are used in this disclosure to refer to one or more than one (i.e., to at least one) of the grammatical object of the article unless otherwise specifically limited to the singular. By way of example, “an element” means one element or more than one element.

As used herein, the term “surface” means the outermost boundary of an object to which a sample such as a tissue is attached, adhered, or placed. In certain embodiments, the surface is substantially flat, Exemplary surfaces include the surface of a mirror, the surface of a block, the surface of a metal sheet, and the surface of a ceramic sheet.

As used herein, the term “positioner” refers to a device or part of a device used to place (i.e., position) a sample on a surface.

As used herein, “about” means a numeric value having a range of ±10% around the cited value. For example, a range of “about 1.5 times to about 2 times” includes the range “1.35 times to 2.2 times” as well as the range “1.65 times to 1.8 times,” and all ranges in between.

### Methods of Placing a Sample on a Surface

The disclosure provides, in part, methods of preserving a sample for histological analysis. In certain aspects, the methods comprise contacting a sample with a surface at low velocities to prevent deformation or distortion of the sample. According to certain embodiments, the sample contacts the surface at 2.5 cm/s or less.

Aspects of disclosed methods comprise actuating a positioner toward a surface at a first velocity. In certain embodiments, to attain the first velocity, the positioner is accelerated until it reaches a maximum velocity. In some embodiments, the positioner decelerates continuously over a period of time to a desired final velocity. In these embodiments, the final velocity is the velocity at which the sample contacts the surface. The final velocity can be 0.05 cm/s to 10 cm/S, 2.5 cm/s to 5.0 cm/s, 5.0 cm/s to 7.5 cm/s, or 1.0 cm/s to 2.5 cm/s. In certain embodiments, the final velocity is 2.5 cm/s.

The methods involve actuating a positioner toward the surface at two or more different velocities. The positioner can be any shape such as a rod, square, or rectangle. In certain embodiments, the positioner is made of a metal such as aluminum, steel, copper, or an alloy. In additional embodiments, the positioner is composed of a ceramic. In other embodiments, the positioner is composed of a plastic. The positioner can be composed of any material so long as the material is resistant to the strain related to contacting a surface at speeds of 0.05 cm/s to 10 cm/s.

The positioner further has a first end and a second end. The first end is located proximal to the surface. In certain embodiments, the first end comprises a magnetic mount that allows for mounting of a solid support to the first end. In some embodiments, the solid support is glass, siliconized glass, ceramic, or metal. In such embodiments, the solid support glass slide) is attached to a magnet. The magnet is then placed on the first end of the positioner so that the sample is facing the surface that will be contacted by the sample. In certain embodiments, the solid support is a glass slide, but can be any material that allows adherence of the sample to the solid support. In particular embodiments, the surface comprises diamond, sapphire, silver, gold, copper, steel, or aluminum. Any thermally conductive material is sufficient for use as a surface. In additional embodiments, a heuser slam tab is utilized as a solid support (Med Vac Inc., St. Louis, Mo.). Such surfaces can be obtained commercially from Leica Microsystems Inc. (Buffalo Grove, Ill.).

In some aspects, the methods also comprise transferring the sample attached to the surface to a freezer. In certain embodiments, the sample is further dried. The sample can be dried using techniques known in the art. For example, the sample can be dried using OsO₄. In some embodiments, the sample is transferred to a sample in a holder. Holders are commercially available from Leica. Microsystems Inc. (Buffalo Grove, Ill.).

In some embodiments, the positioner is movably attached to a guide such that the positioner is normal to the surface to which the sample is to be contacted. In certain embodiments, the surface is inclined 30 degrees relative to horizontal and the positioner is normal to the inclined surface.

It should be noted that the methods further allow for the surface to be cooled. The surface can be cooled using a coolant such as liquid nitrogen or liquid helium. Both liquid nitrogen and liquid helium are commercially available and have been used by those of ordinary skill in the art for decades. In addition, liquid nitrogen and helium containment systems are commercially available (See, e.g., Leica Microsystems Inc., Buffalo Grove, Ill.). In certain embodiments, the surface is lowered into a container having the coolant. In many embodiments, the surface is cooled to a temperature sufficient to permit rapid freezing of the sample. This can be different depending on the sample. However, in some embodiments, the temperature of the surface is less than or equal to 150 Kelvin. In other embodiments, the surface temperature is less than or equal to 100 Kelvin. In some embodiments, the surface temperature is around 70 Kelvin. In other embodiments, the surface temperature is cooled to less than 50 Kelvin. In certain embodiments, the surface is cooled from a time prior to the positioner being movably attached to the guide.

As noted above, the disclosed methods comprise moving a positioner toward the surface and then accelerating/decelerating the positioner to obtain at least two different velocities. These methodologies allow for samples to be preserved without damaging samples due to contact velocity. According to the disclosed methods, a first velocity is attained during a first phase of actuating the positioner toward the surface. In some embodiments, the first velocity is greater than or equal to 3.0 m/s. In other embodiments, the first velocity is greater than or equal to 4.0 m/s. In some embodiments, the first velocity is 4.5 m/s.

During the first phase, the positioner is accelerated toward the surface to attain the first velocity. Such acceleration generally occurs when the positioner reaches a first location on the guide. In some embodiments, the positioner reaches the first velocity prior to reaching the second location on a guide. In certain embodiments, the positioner is accelerated at greater than or equal to 100 m/s². In other embodiments, the positioner is accelerated at 100 m/s².

In further embodiments, the positioner reaches a first position on a guide to which the positioner is movably attached. In certain embodiments, a sensor is located at the first location. In particular embodiments, the sensor comprises a laser. Laser sensors can be obtained commercially from Keyence Corp, (Elkhorn, Wis.). In these embodiments, the sensor detects the leading edge of a sample attached to the solid support that is affixed to the first end of the positioner. In some embodiments, the information that the leading edge of the sample reached the first location on the guide is sent to a computer. In such embodiments, the information is used to calculate the distance remaining in the first phase. In some embodiments, the velocity of the positioner is used to calculate the distance remaining to the surface. In certain embodiments, the time to the surface is calculated. In other embodiments, the time to a location on the guide is determined based on the velocity and/or acceleration of the positioner. The location on the guide, in these embodiments, is a second location located distal from the first location and the second location is the location at which the positioner decelerates. This information can be used to determine when the first phase ends and the second phase begins.

In particular aspects, the disclosed methods comprise attaching a sample to a surface. In these aspects, the method comprises contacting the sample to the surface at a contact velocity of 0.05 cm/s to 10 cm/s, wherein the sample is affixed to a first end of a positioner and wherein the sample freezes after contacting the surface. In some embodiments, the positioner approaches the surface after reaching a maximum velocity.

In the disclosed methods, the positioner continues at the first velocity toward the surface until the positioner reaches a second location on the guide. The location on the guide demarcates the end of a first phase and the beginning of a second phase. At the beginning of the second phase, the positioner is decelerated. In certain embodiments, the positioner is decelerated at 150 m/s² after reaching the second location on the guide to attain the second velocity. In some embodiments, the positioner is continuously decelerated after reaching a maximum velocity. In other embodiments, the positioner is decelerated at 100 m/s² or greater. In certain embodiments, the positioner is decelerated at 20 m/s² or greater or 50 m/s² or greater. In some embodiments, the contact velocity is 0.05 cm/s to 10 cm/s. In other embodiments, the contact velocity is 5 cm/s to 7.5 cm/s. In some embodiments, the contact velocity is 2.5 cm/s. In these embodiments, once the second velocity is attained, the velocity is maintained until the sample contacts the surface. It should be noted that this “deceleration” phase can last for less than or equal to 0.5 seconds. In some embodiments, once the contact velocity is reached, the positioner will travel the final distance to the surface in approximately 0.1 seconds. In certain embodiments, the positioner travels the final distance to the surface in less than or equal to 0.2 seconds.

In other embodiments, after actuation of the positioner, the entire time period that the positioner takes to position the sample on the surface is less than or equal to 0.2 seconds. In some embodiments, the positioner moves across the final distance or the “deceleration” phase in less than or equal to 0.1 seconds.

In some aspects, the methods disclosed herein comprise pre-determining the first and second velocities and storing the information on a memory in a computer. A personal computer is a non-limiting example of a computer that can store the first and contact velocities for sample preparation. In additional embodiments, the acceleration and deceleration profiles can be stored. Furthermore, the computer can use a timer or counter to determine the length of the first and second phases. In some embodiments, the computer controls the velocity of the positioner, the acceleration or deceleration of the positioner, and receives information from the sensor regarding the leading edge of the sample attached to the solid support, which is affixed to the first end of the positioner.

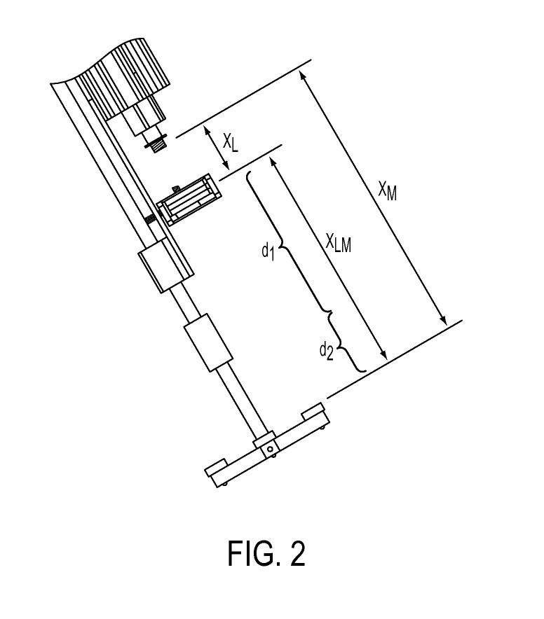

A two-phase methodology is shown in FIG. 2. The phases are shown as compared to the positioner and the guide. As shown in FIG. 2, the entire distance from the loading position of the positioner (in this case, a motorized actuator) to the surface is X_{M}. This distance represents the entirety of the distance that the positioner will travel during both phases. X_{L} represents the distance from the loading position of the positioner to the first location on the guide, which has a sensor at this position. In certain embodiments, this distance is the distance that the positioner moves prior to being accelerated to the first velocity. In other embodiments, this distance is included in the “first phase” along with D₁, which is the distance from the first location to the second location on the guide. In these embodiments, the positioner is accelerated from the loading position to the first velocity and continues through the first location with the sensor. In either instance, the first phase is also known as the “fast approach.” The first phase is characterized by the positioner reaching velocities of 4.5 m/s. D₂ represents the “second phase.” As shown in FIG. 2, the second phase begins at a second location on the guide and continues to the surface. As noted above, it is during this distance that the positioner is decelerated to its contact speed, which can be as low as 0.05 cm/s. The second phase is also referred to as the “slow contact” phase. X_{LM} is the distance from the sensor to the surface and encompasses D₁ and D₂. In certain embodiments, D₁ is more than two times longer than D₂. In other embodiments, D₁ is as long as D₂. In some embodiments, D₁ is more than four times longer than D₂.

It should be noted that some embodiments of the methods and devices disclosed herein utilize information regarding the position of the sample relative to the surface. In some embodiments, a location on the guide defines a total distance from the sample to the surface. For instance, a particular point on the guide defines a distance to the surface. When the leading edge of the sample intersects this point, the distance to the surface is identified. In some embodiments, the positioner is accelerated to the surface for a period of time. In other embodiments, the positioner is decelerated until the sample contacts the surface. In still further embodiments, the total distance is divided into at least a first distance and a final distance from the sample to the surface. In some embodiments, the final distance is defined by a second location on the guide. The final distance (e.g., D₂) can also be called the “deceleration” distance or final approach distance. In certain embodiments, the positioner travels the final distance to the surface in a total time of less than or equal to 0.1 seconds. In some embodiments, the time to the second location is determined based on the determination that the sample has reached the first location on the guide.

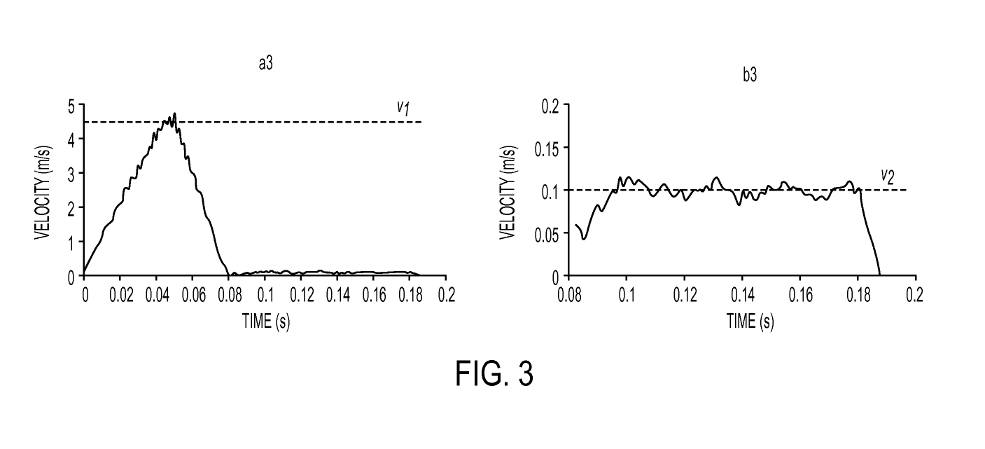

Returning to the “two phase” methodology, this is further shown in FIGS. 3a and 3b. When the sample interrupts the sensor of a device (e.g., a laser sensor), the first phase is triggered and the sample is accelerated through the cold nitrogen vapor to reach a maximum velocity of 4.5 m/s (v1). Upon reaching a second location on the guide, the positioner reaches the second phase and decelerates the sample to a velocity (v2) as low as 0.05 cm/s for the final 0.1 seconds of time that the positioner travels down the guide whereupon contact with the surface (e.g., copper mirror) is made. FIG. 3a shows the entire velocity profile for a run with a 10 cm/sec for the second phase velocity. The dashed line in FIG. 3a represents a user selected maximum velocity, v1, of 4.5 nix. This velocity can be stored in the memory of the computer controlling the positioner. FIG. 3b shows only the second phase velocity of 10 cm/sec. This velocity can also be selected by the user as the selected approach velocity, v2, indicated by the dashed horizontal line. This velocity can be stored in the memory of the computer, controlling the positioner,

### Devices for Preserving Samples

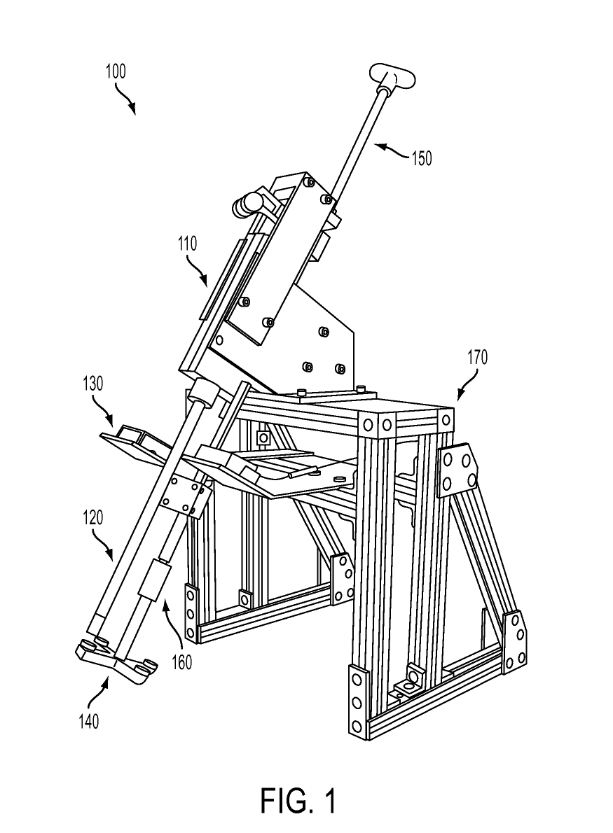

An exemplary sample preservation device that accomplishes the methods disclosed herein is shown in FIG. 1. The device 100 includes a positioner 110, which is a magnetized linear motorized slider (LinMot, Inc. Elkhorn, Wis.). The positioner 110 is positioned on a guide 120. Notably, the positioner 110 does not have to be a motorized slider. For instance, the positioner 110 can be a plunger operated by a spring mechanism. Other types of positioners are known in the art that are capable of accurately positioning a sample on a surface (Leica Microsystems Inc., Buffalo Grove, Ill.).

Returning to FIG. 1, the guide 120 is a linear motor stator. The guide 120 allows the positioner 110 to move downward toward the surface (e.g., polished copper mirror) 140. Other guides are known in the art and the disclosed guide is not intended to be limiting. A guide need only hold a positioner in place and allow the positioner to accurately position a sample on a surface. It should be noted that a guide is not required to accurately position a sample. For instance, a human could place a sample on a surface using a positioner without a guide. The positioner 110 is disposed on the guide 120 such that the positioner 110 moves only upon a controller's command to move. In certain embodiments, the controller is a human. In other embodiments, the controller is a computer (not shown). In FIG. 1, the positioner 110 is controlled by a E1100 Servo Controller (LinMot, Inc., Elkhorn, Wis.) (not shown). Other controllers can be used within the scope of the disclosed device and the disclosed controller is not limiting. The sensor 130 information and positioner 110 information is transmitted to a personal computer via an RS232 connection. The personal computer (not shown) in this embodiment runs LinMot Talk version 4.0 controller software (LinMot, Inc., Elkhorn, Wis.).

The positioner 110 can be disposed on the guide 120 in a multitude of ways to allow for controlled movement. Such techniques include the guide 120 having tracks, grooves, or a surface that allows objects to slide down the guide's length. In some embodiments, the guide 120 is a rod and the positioner 110 has an opening and tube that allows the guide 120 to move through the interior of the positioner 110. In such an embodiment, the positioner 110 slides down guide 120. In some embodiments, the positioner 110 reaches the surface 140 in less than 0.3 seconds after the positioner 110 is actuated. In other embodiments, the positioner 110 is actuated and reaches the surface 140 in less than or equal to 0.2 seconds.

In addition, the first location on the guide 120 is defined by the sensor 130, which is a laser sheet in this embodiment. The positioner 110 moves down the guide 120 and passes the sensor 130 as it approaches the surface 140. In some embodiments, the combination of a positioner 110 (e.g., magnetic induction linear motor) and sensor 130 (e.g., wide beam laser sensor) allows for accurate measurement of the distance the sample is to travel to make contact with the surface 140 (e.g., mirror).

In certain embodiments, the positioner 110 is connected to a guide 120 such that the positioner 110 rotates 45 degrees or more around the guide 120 to form an arc in which the guide 120 is disposed at the center of the arc. A sample is attached to the first end of the positioner 110, the first end being distal to the guide 120. Upon actuating the positioner 110, the positioner 110 forms the arc and contacts a surface 140, which is aligned with the path of the first end of the positioner 110 such that the sample contacts the surface 140. In certain embodiments, the guide 120 is a stepper motor.

In the embodiment shown in FIG. 1, the positioner 110 is normal to the surface 140, which is held in position at 30 degree incline from horizontal. It should be noted that the surface can be held in position by a support (not shown). The support can be fiberglass, steel, iron, or any material capable of supporting the surface 140 during contact of the sample to the surface. Furthermore, the support can be adjustable to allow for the inclination of the surface 140 to be adjusted.

In certain embodiments, the surface 140 is further cooled in liquid nitrogen (not shown). The liquid nitrogen is provided in a container that allows the surface 140 to be cooled sufficiently to freeze the tissue following contact with the surface 140.

Furthermore, the device 100 frame is composed of 80/20 extruded aluminum. As noted above, other metals including steel, plastic, and iron can be used for the frame so long as the material withstands the stress of device operation. As shown in FIG. 1, the device 100 has a frame 170 that has six legs, four of which are perpendicular with the ground and two of which contact the ground at an angle. In addition, the frame 170 has a platform on which a support for the guide 120 and positioner 110 rest. The frame 170 shown in FIG. 1 is not meant to be limiting, but to show one way to build a device within the scope of the disclosed devices. Any support frame can be used for the device so long as the device allows for a positioner to position accurately a sample on a surface for freezing of the sample.

The device 100 further comprises a surface 140 rotator handle 150. The rotator handle 150 allows for the user to rotate a support (not shown) of the surface 140 to allow for surfaces to be rotated into the contact position. Furthermore, the device 100 contains a failsafe brake 160 to stop the progress of the positioner 110 when the device 100 is in use.

The device 100 performs the methods disclosed herein. For instance, the device allows for an initial velocity (phase 1) to be chosen so that it is rapid enough to move the sample very close to the mirror with a small “dwell time” in the nitrogen vapor and to minimize the time from sample loading to sample freezing. The final approach velocity (phase 2) is attained over the last few millimeters to assure both a controllable “touch” and minimum time in the cold vapor. This phase avoids the deformation caused by slam freezing. In certain embodiments, this phase is minimized in terms of its distance.

Returning to FIG. 2, the device 100 allows for the user to pre-determine the velocities as well as the length of the two phases based on the system geometry with the distance from the sample to the mirror, X_{M}, divided into the detection distance, X_{L}, and the distance to the surface 140 (e.g., polished mirror), X_{LM}. X_{LM} is further divided into the distance over which the sample moved rapidly, d₁ and the distance over which the sample attained the controlled approach (impact) speed, d₂. Mathematically, d₂ is defined first because it is required to set d₁, as:

d₂=v₂t₂

Where the time of the second phase, t₂, and the second phase impact velocity, v₂, are defined by the user. Using d₂, the first phase distance, d₁, can be defined as

d₁=X_{LM}−d₂

The first phase max velocity, v₁, is input by the user to complete the parameter set, which defines
the dual phase velocity profile. FIG. 3 shows the actual motor kinematics confirming that the disclosed device 100 attains v₁.

### Examples

### Identification of Contact Speeds for Samples

The device 100 shown in FIG. 1 was used to determine the distortion/deformation of samples contacting the polished mirror surface 140 at different velocities. Table 1 shows the different velocities and the accelerations/decelerations.

TABLE 1

| | | | Phase 1 | | Phase 2 | |
|---|---|---|---|---|---|---|
| v₂ | v₁ | d* | Accel | Decel | Accel | Decel |
| (m/s) | (m/s) | (m/s) | (m/s²) | (m/s²) | (m/s²) | (m/s²) |

| | | | | | |
|---|---|---|---|---|---|
| 2.5 | 4.5 | 1 | 100 | 150 | 10 |
| 5 | 4.5 | 1 | 100 | 150 | 10 |
| 10 | 4.5 | 1 | 100 | 150 | 10 |
| 30 | 4.5 | 1.2 | 100 | 150 | 100 |

Parameters which define the dual-phase velocity profiles in Table 1 are as follows. d* is an additional distance added to the phase 2 distance, d₂, to ensure the sample makes contact with the mirror during the slower impact velocity instead of stopping short of the surface. Accel/Decel refers to the acceleration used to achieve the requested velocity. The device is capable of ˜150 m/s².

For the tests of the device 100, the first velocity, v1, was set to 4.5 m/s, while the second velocity, v2, was set to 2.5, 5, 10, or 30 cm/s. Referring to FIG. 3a, a typical dual phase velocity profile is shown from the tests, the dual phase profile being a typical profile for the methodologies disclosed herein. As is apparent from the profile, the first velocity, v1, of 4.5 m/s was achieved and the second velocity for the 10 cm/s tests was also achieved as shown in FIG. 3b. Furthermore, during the second phase set to v2, the sample is exposed to the cool N₂ vapor for 0.1 seconds.

### Touch Freezing Using Two-Phase Methodology

Sample distortion was also determined using the two-phase approach disclosed herein. The tests disclosed herein captured sample distortion in the vitrified region of a frozen sample (up to 20 microns in depth). To permit the quantification of the deformation of a sample caused by impact freezing, a custom deformation assay including an ersatz tissue sample material was developed. Briefly, the ersatz tissue comprised a highly-hydrated, translucent Laponite clay (Southern Clay Products, Gonzales, Tex.) infused with 3 micron diameter particles. Laponite clays exhibit rich rheological behavior and at low salt concentration behave as a repulsive glass with very low yield strength. Thus, plastic deformations can be readily induced in the clay by application of stress or by impact and remain in place once the stress is removed. By including microspheres in the clay material, pre- and post-freezing point clouds are generated by combining optical microscopy and particle detection image processing. Deformation (strain) fields were readily extracted from the point clouds by measuring the relative instances and angular displacements between bead pairs.

To make the ersatz tissue sample Laponite powder was added to deionized water at a 10% (w/v) concentration. A 5 μL/ml concentration of 3 μm diameter polystyrene microspheres (Polysciences, Inc., Warrington, Pa.) was then added to the solution. The mixture was continuously agitated for 10 minutes, ensuring full homogenization. A new solution was generated and used on the same day or it was discarded.

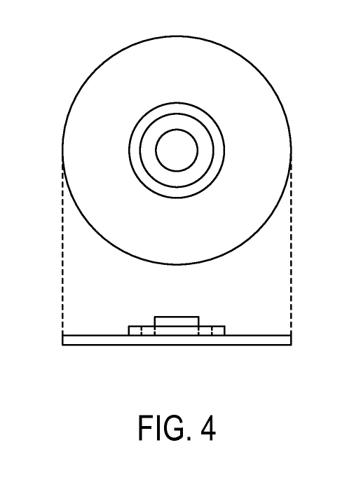

A glass slide was prepared to accept the new solution sample by securing a small plastic O-ring on the center of the slide with epoxy. A column of the prepared Laponite (approximately 5 mm diameter by 2 min height) was formed on the glass slide within the O-ring using a PDMS mold to ensure consistent width, height and protrusion above the O-ring surface, FIG. 4 shows the sample and holder geometry. The O-ring served as a hard stop, ensuring all the samples were compressed to a consistent thickness during contact with the metal mirror. Glass fiber particles were then scattered on the top surface of the Laponite sample to act as low resolution fiduciary markers.

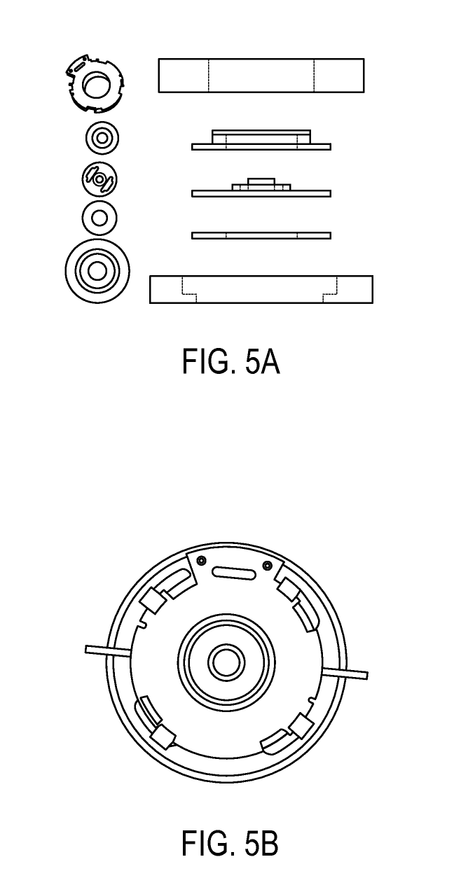

The formed sample surrounded by two annular layers of silicon (FIGS. 5a and 5b) and was secured inside the self-locking base of a FCS2 microchamber (Bioptechs, Bulter, Pa.). When the chamber was covered and locked, the silicon rings were pressed against the slide, completely sealing the sample within this tight space to minimize dehydration effects during imaging. To minimize the effect of evaporation, the samples were formed and sealed inside a commercially available Bioptechs FCS2 chamber with modifications to minimize the volume of air around the sample.

The sealed sample was observed on an inverted microscope (Nikon TE2000E, Tokyo, Japan) equipped with a Nomarsky prism out for differential interference contrast (DIG) imaging. The top surface of the sample (immediately below the glass surface) was scanned at 100× magnification to find a region of interest. A picture of the sample surface (including glass fibers) was taken of the selected region of interest (CoolSNAPHQ2 1394; Photometric, Pleasanton, Calif.). This image was used as a reference for finding the same region on the post-frozen sample. A Z-scan of 100 images was then taken at 200× magnification from the top surface of the region of interest downward at 0.5 μm depth intervals.

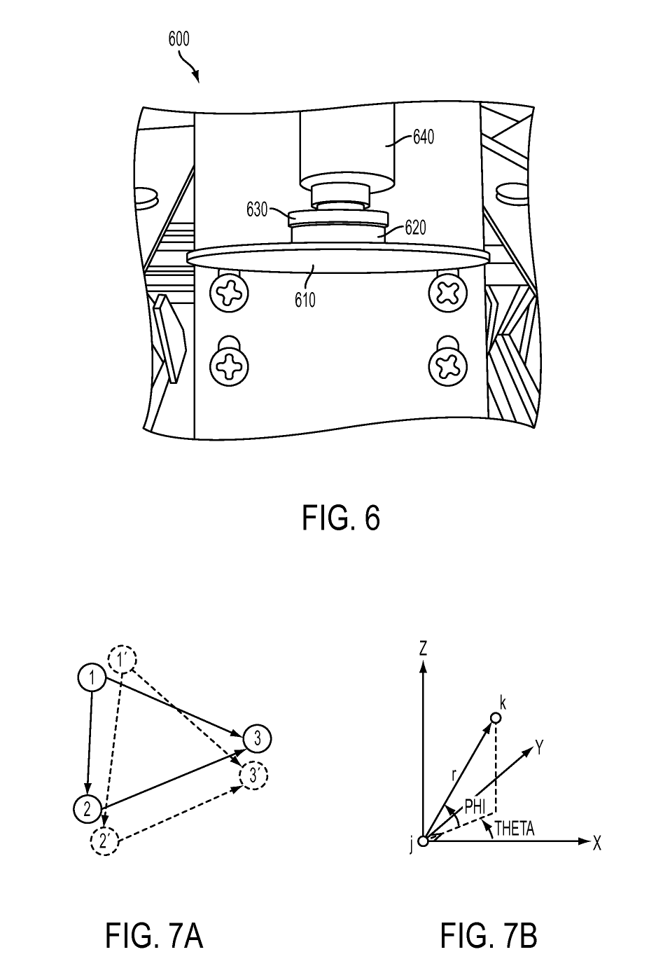

Touch freezing was performed using device 100 following the procedures set forth below. Once the image Z-scan was complete, the sample was carefully removed from the FCS2 chamber, and quickly (<10 seconds) transferred to the touch freezer to minimize sample dehydration. It was attached by double-sided tape to a foam cushion fixed to a magnetic mount The complete sample stack was mounted onto the slider of the touch freezer (FIG. 6). To minimize the time between sample imaging and freezing the touch freezer had already been calibrated and programmed with the appropriate dual velocity profile.

To calibrate the touch freezer, four copper mirrors were polished, secured onto the mirror module, and cooled using liquid nitrogen. After the mirror module reached 77K (approximately 5 minutes), it was rotated and locked in place to expose a cooled mirror. The system was then calibrated to define and calibrate the geometry over which the sample would traverse during a freezing event. Briefly, calibration involved measuring the distance, X_{LM} between the sheet laser and the surface of the mirror. See FIG. 2 for more details. First, the motor is switched on and the slider is initialized to its home position. Home is defined as the front face of the slider being 10 mm below the front face of the stator. Since the slider will briefly make contact with the mirror during the calibration sequence, a magnetic adaptor is then attached to the front face of the slider. It has an extruded semicircular lip that makes contact with part of the outer edge of the mirror to avoid contact with center of the mirror where the sample will make contact. During the calibration sequence, the operator manually moves the slider, with the adaptor attachment, until it makes contact with the mirror, and records the distance (X_{M}) displayed by the software. The slider is then homed and a command is initiated to advance the slider at 1 mm/s until the first interference with the laser beam sensor is detected, upon which the motor slops. The user or system then records this distance as well (X_{L}). The difference (X_{LM}) is the distance from the laser to the mirror surface.

After calibration, the polished copper mirrors were pre-cooled in the liquid nitrogen and ready to contact the sample. The sample was then touch frozen with a second phase impact velocity of 2.5, 5.0, 10, or 30 CM/S using the preprogrammed dual-phase velocity profile. Six samples were touch frozen at 2.5, 5.0, and 10 cm/s, and five samples at 30 cm/s. To confirm that the touch velocity profiles were accurate for each run, time, velocity, and distance data was collected using the built-in oscilloscope feature of the LinMot application software.

After the sample was touch frozen, it was removed from the device and allowed to come to room temperature for 4 minutes before being placed back into the FCS2 chamber to prevent dehydration and to permit re-imaging. The sample was quickly scanned to locate the glass fiber pattern corresponding to the initial region of interest. A confirmation image of this region was taken followed by a Z-scan with images obtained in the same manner as the pre-frozen sample. The post-freezing imaging process was kept to less than ˜3 min.

A control test was devised to measure the thrust effects of the first phase of the velocity profile on the sample. To perform the test, the freezer was programmed to follow only the first phase of the dual-phase velocity profile, as the acceleration and deceleration achieved in this phase were significantly greater than those of the second phase. To restrict the measurement to thrust effects only, the sample did not make contact with the mirror nor was it permitted to freeze. The sample preparation, handling, pre-acceleration imaging and post-acceleration imaging were performed FIG. 6. Photograph of sample mounted on motor slider immediately prior to touch freezing event. The sample on its glass mount 610 was adhered to foam backing 620 which was in turn adhered to the magnetic mount 630 magnetically affixed to the first on of the motor slider positioner) 640.

### Image Processing

Processing of the image sets was performed with custom MATLAB (MathWorks, Natick, Mass.) algorithms. To generate a 3-dimensional point cloud from the microspheres from the Z-scans, it was necessary to identify the position of each microsphere in 3-space. To accomplish this, a two dimensional cross correlation was performed on each scanned image within a set using a template image of a single focused microsphere. From this, the x-y coordinates of any microsphere location with at least a 0.8 correlation to the template (with a max of 1.0) were obtained. Correlation values occurring at the same x-y coordinates over consecutive image frames were plotted against their frame, and a parabolic line was fit to the data. The local maximum indicated in which frame (z-coordinate) a microsphere was focused. The result of this approach was a three dimensional point cloud of the microspheres within a sample. The process was objective, repeatable and provided robust microsphere position data from the pre- and post-freezing Z-scans. To ensure the method accurately identified the z-position of microspheres within the Laponite, an independent observer was asked to find the z-position of ten random beads in one of the Z-scan image stacks. The observer was asked to repeat the process two more times (finding the microspheres in a different order) and the results were averaged and compared to our algorithm. We found that the observer and algorithm agreed to within 1.75±0.7 microns. We also found that the observer always found the microspheres to be deeper than the automatic algorithm so most of the difference was systematic.

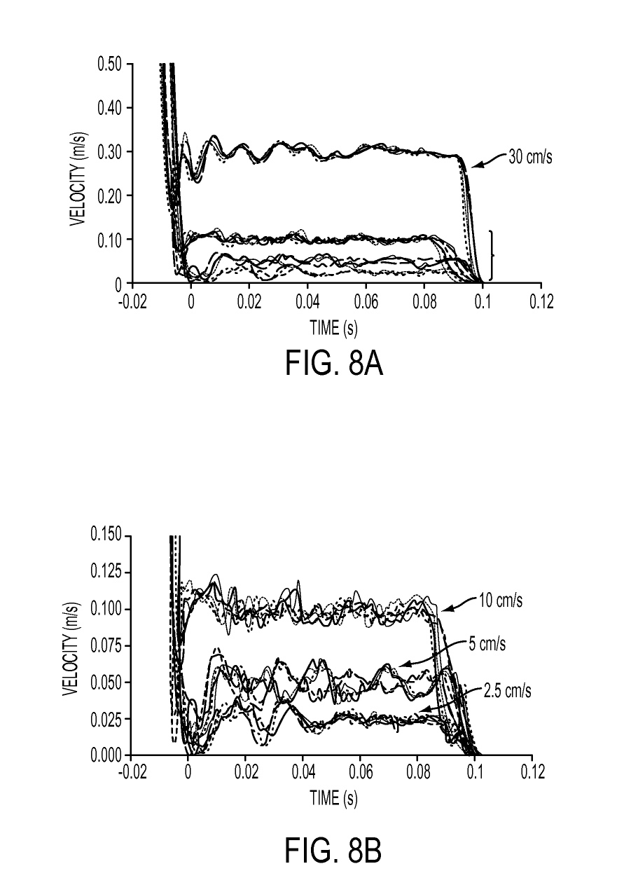

By comparing the positions of microspheres before and after freezing, the effect of the impact with the surface on the sample was isolated. In mechanics, the deformation of a sample is typically estimated via the strain or stretch ratio. FIG. 7 illustrates the strain estimation method and coordinate system used in our investigation. To find the strain induced in our sample, corresponding microspheres were identified in pre- and post-frozen image data sets (FIG. 7a). The 3-dimensional positions of the microspheres were input into a set of custom strain calculation algorithms (written in MATLAB) In the program, the positions of the correlated microspheres were converted from Cartesian (X, Y, Z) to spherical (r, theta, phi) coordinates. For every microsphere pair (before and after freezing), the relative distance between beads (rxy and r′xy) and relative angles were determined. Using these data, the linear strain and angular changes (shear strains) were calculated. An average strain value for each impact velocity was obtained and reflects the magnitude of distortion of the point cloud caused by the freezing event.

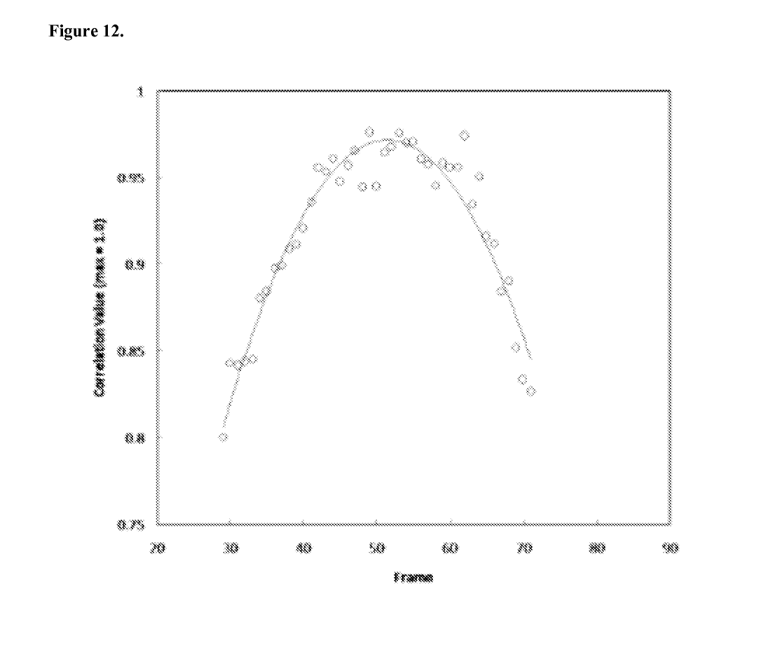

Furthermore, a set of algorithms calculated the distance from each microsphere to another, converted these coordinates from cartesian (x, y, z) to spherical (r, theta, phi), calculated changes in r, theta, and phi from initial to final sets for each length, calculated an absolute stretch ratio (Δr/rᵢₙᵢₜᵢₐₗ), an absolute change in delta, and an absolute change in phi for each length, and the average and standard deviation for the absolute values. To do this, a two dimensional cross-correlation was performed on each image using a bead template defined by the user. The template was a focused bead from the image set. The highest correlated bead positions were sorted and written to an Excel file. Each bead increased in correlation value as it gets more focused (i.e., image focal plane approaches the bead's focal plane from below the bead as the scan progresses upward through the sample). The more focused a bead gets in an image, the more it matches the template, until a max correlation value is reached. The bead then loses correlation value as the image's focal plane gets further from the bead's focal plane as the scan continues above the bead. The correlation values for each bead in the image set were plotted, and a second order equation was fitted on the points. The inflection point was calculated as the frame where the bead is focused. An example of this is shown in FIG. 12. In this case the inflection point, signifying the center of a bead (Le., focused), is frame 92.

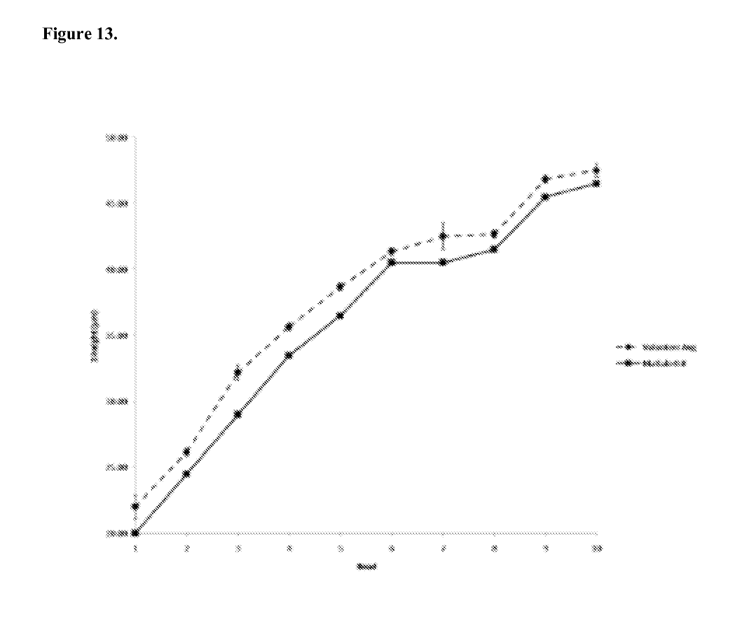

The accuracy of the algorithm's ability to calculate a bead's focal frame was compared to manually calculating it. A volunteer looked through a set of images, and picked the center frames of ten random beads. This was repeated with the same beads two more times, and averaged over the three runs. The results were compared to the algorithm's results for the same ten beads and are shown in FIG. 13. The algorithm calculated a bead's center frame an average of 3.5 (±1.4) microns lower than the volunteer. This shows the algorithm's ability to repeatably calculate a head's center frame.

When all the beads centers were calculated, two plots were generated. The first included the XY positions of each bead projected onto a plot, and the second included the same, but only for the top 60 frames (30 microns) from the sample surface.

The corresponding beads between the two image sets were matched, and the matched three dimensional coordinate data were entered into a second set of algorithms. The positions of these beads are converted from a Cartesian (x, y, z) to a spherical (r, delta, phi) coordinate system. The algorithms perform various calculations using the spherical coordinates of the beads and save the final data to an Excel file. An example of such data includes a stretch ratio and changes in delta and phi between every bead pair in the sets. The stretch ratio, SR, is defined as

SR=r^{f}_{ab}/r^{I}_{ab}

In the above equation, r_{ab}, is the distance r between two corresponding heads of the pre- and post-frozen image set, i and f, respectively. The changes in delta and phi are, similarly, the differences in delta (angle about the Z-axis) and phi (angle from the XY plane) between every corresponding bead pair in the sets.

To determine if the approach velocities through the nitrogen vapor strongly influence the surface temperature of a sample, we constructed a thermal model capable of simulating the conditions that our device produces during a typical “touch” or “slam” freeze event. The goal was to understand whether or not our method of touch freezing would substantially depress the surface temperature and compromise the high thermal gradient necessary to vitrify the water at the sample surface. The thermal analysis was performed on the final 10 cm of the sample's approach to the mirror surface for each velocity profile. Ten centimeters was used since that is the distance from the surface of the active mirror to the top of the container that holds the liquid nitrogen.

The model sample was a 1 min thick, 10 mm diameter cylinder. To simulate tissue, the initial thermal properties of the material cylinder were set to equal that of pure water at room temperature. The values used in the simulation are tabulated in Table 2. For Table 2, initial thermal properties of pure water used to simulate tissue. Initial temperature (T0), specific heat capacity (Cp), thermal conductivity (k), density (ρ), and thermal diffusivity (α).

TABLE 2

| TInf (K) | T0 (K) | Cp (J/kgK) | k (W/mK) | p (kg/m3) | α (m2/s) |
|---|---|---|---|---|---|
| 73 | 293 | 4184 | 0.5985 | 998.21 | 1.43E−07 |

To simulate the velocity during the final 10 cm of travel, each profile was broken down into its respective velocity and time properties. For this analysis, a constant velocity profile of 4.5 m/s was compared to the three dual-phase velocity profiles. The velocity breakdown for each experimental profile is shown in Table 3.

TABLE 3
Constant Velocity Profile

| Distance (m) | Velocity (m/s) | Time (s) |
|---|---|---|
| 0.1 | 4.5 | 0.022 |

Dual-Phase Velocity Profile*

| | Time, t (s)** | Velocity, v (m/s) | Distance (m) |
|---|---|---|---|
| Section A | 0.00696 | 4.5 | 0.03132 |
| Section B | 0.02925 | v = −153t + 5.56482 | 0.0661742 |
| Section C | 0.1 | 0.025 | 0.0025 |
| Section A | 0.00643 | 4.5 | 0.028935 |
| Section B | 0.02908 | v = −153t + 5.48396 | 0.0660534 |
| Section C | 0.1 | 0.05 | 0.005 |
| Section A | 0.00535 | 4.5 | 0.024075 |
| Section B | 0.02876 | v = −153t + 5.32008 | 0.066143 |
| Section C | 0.1 | 0.1 | 0.01 |

* Total distance for each Dual-Phase Profile (Section A+Section B+Section C) is 0.1 m. Section A is the tail of the first phase velocity, Section B is the deceleration to the second phase velocity, and Section C is the second phase velocity.
** Each time represents the duration of each phase (i.e. For the first set, Section A is from time, t=0 to t=0.00696, Section B is from t=0.00696 to t=0.03621, and Section C is from t=0.02925 to t=0.12925, each section lasting for 0.00696, 0.02925, and 0.1 seconds, respectively).

To simulate the thermal conditions produced by a freezing event, a one dimensional, transient thermal analysis of the sample through the final 10 cm of its velocity profile was performed. It was assumed that the (ambient) temperature of the final 10 cm was the temperature of liquid nitrogen (78 K), and that the temperature above that surface was room temperature (293 K). The motion and geometry of the transit was modeled as a liquid water disk moving perpendicular to a uniform vaporous nitrogen flow.

To check the accuracy of the 1-D nodal model and to estimate the effect of the three-dimensional geometry (the 1-D model calculates an average surface temperature), the freezing event was modeled using commercial finite element software. The same tissue, geometrical values, velocity, and thermal properties were used in the simulation. The sample was created (all-hexa mesh with approximately million elements) using ANSYS, ICEM-CFD (ANSYS® Academic Research, Release 14.0, Canonsburg, Pa.). The analyses were performed in Fluent. Temperature values along the centerline and edge of the sample were compared.

### Results

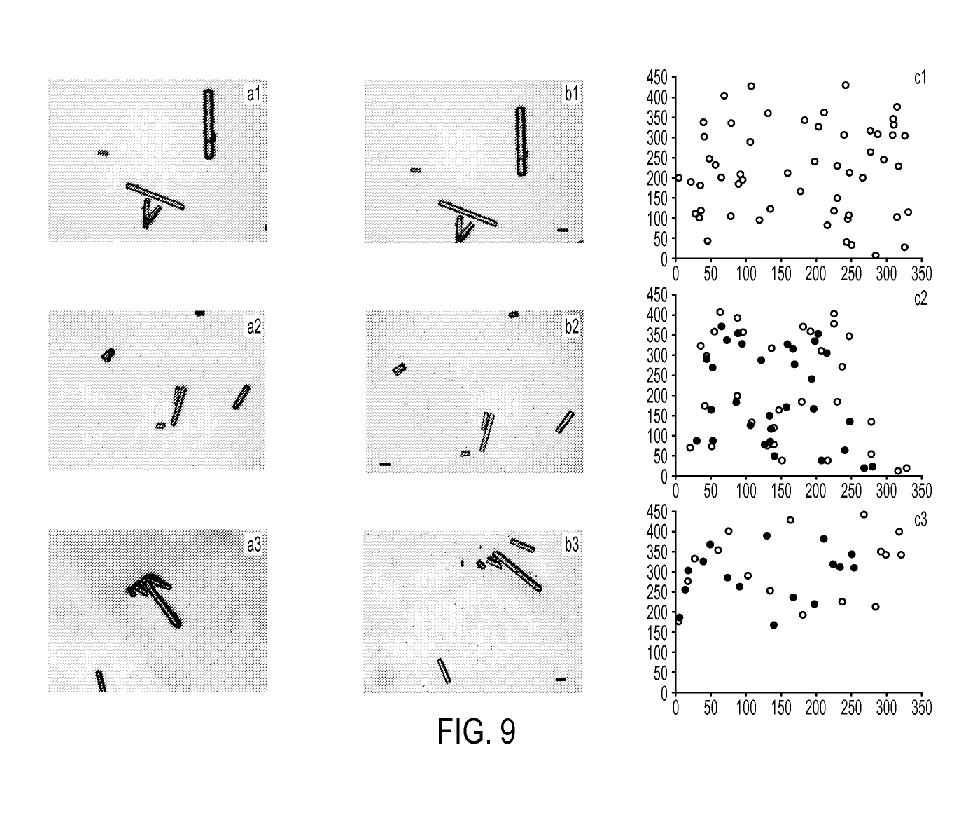

Using data captured by the digital oscilloscope provided in the linear motor control software, the second phase of the approach profile (second velocity) was monitored to ensure that the time interval was 0.1 seconds duration and that the magnitude of the velocity matched the requested value (v2). FIGS. 8a and 8b show a compilation of the second phase velocity profiles for all experiments. As seen in FIGS. 8a and 8b, the device 100 was able to attain consistent velocities across tests. Table 4 shows the measured velocity average and standard deviation of the sample at impact with the mirror.

TABLE 4

| Target Impact Vel. | Avg. Meas. Impact Vel. | St. Dev. |
|---|---|---|
| (cm/s) | (cm/s) | (cm/s) |
| 2.5 | 2.41 | +0.37 |
| | | −0.42 |
| 5 | 4.89 | +0.40 |
| | | −0.55 |
| 10 | 10.10 | +0.35 |
| | | −0.23 |
| 30 | 28.99 | +0.00 |
| | | −1.01 |

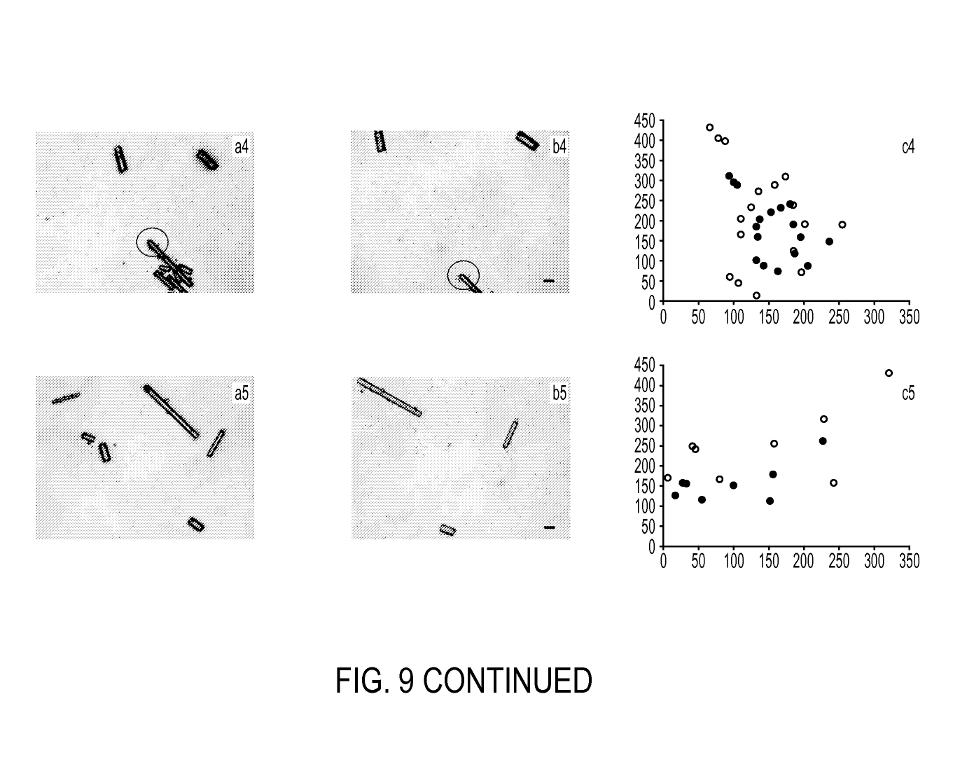

FIG. 9 demonstrates the effect of increasing impact velocity (v2) on the quality of sample preservation. It can be readily appreciated that even the lowest impact velocity caused the glass fiduciary markers to shift (2.5 cm/sec, v2; compare FIG. 9a2 to FIG. 9b2), while the control sample remained relatively undisturbed (no impact freezing; compare FIG. 9a1 and FIG. 9b1). FIG. 9 (column c) shows typical X-Y projections of correlated beads before and after touch freezing for each v2. From these plots, the distortion of the bead clusters generally increases with v2 and that there are fewer beads which could be correlated as v2 increases. There is a clear qualitative increase in sample distortion with increasing impact speed. Nevertheless, the distortion is markedly decreased as the contact speed (v2) decreases.

Results from the MATLAB analysis (average point cloud strain and standard deviations) for each impact velocity and their control are summarized in Table 5.

TABLE 5

| Impact Velocity | | Stretch | | |
|---|---|---|---|---|
| (cm/s) | | Ratio | Δtheta | Δphi |
| Control | Average | 1.003 | 1.336 | 1.360 |
| | St Dev | 0.001 | 0.187 | 0.041 |
| 2.5 | Average | 1.243 | 4.014 | 3.172 |
| | St Dev | 0.062 | 0.986 | 0.967 |
| 5 | Average | 1.278 | 7.947 | 4.084 |
| | St Dev | 0.102 | 3.213 | 1.200 |
| 10 | Average | 1.325 | 6.929 | 4.773 |
| | St Dev | 0.136 | 3.152 | 0.978 |
| 30 | Average | 1.667 | 8.600 | 6.466 |
| | St Dev | 0.265 | 3.154 | 2.333 |

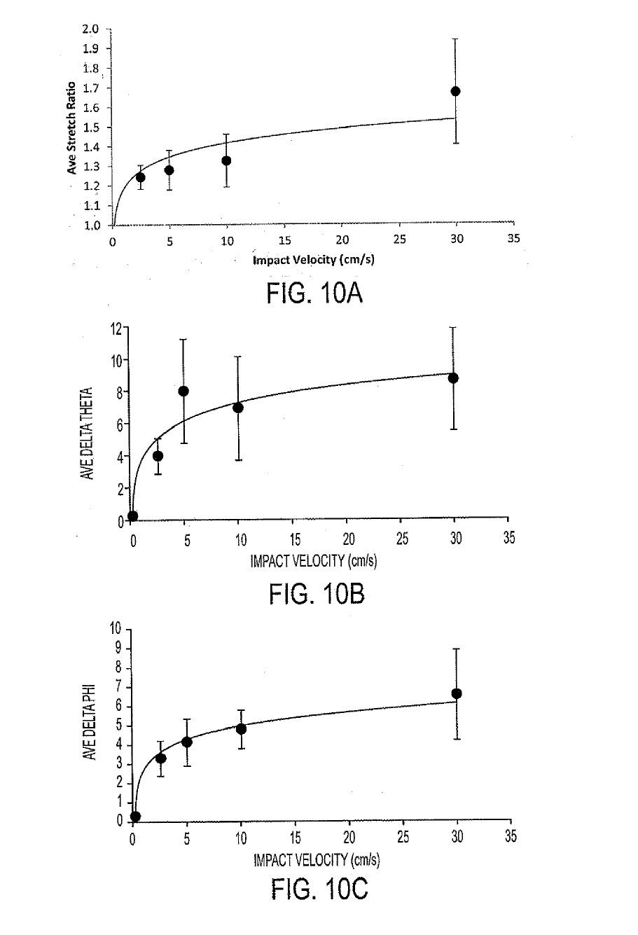

FIGS. 10a, 10b, and 10c show the average stretch ratio and angle change curves for the control and each impact velocity from Table 5. The standard deviation of average stretch ratio and angle changes for each set is shown in the y-axis error bars. The control's error bars are too small to be visible in this scale. As is apparent from the figures, the stretch ratio and angle changes decrease as contact velocity decreases. Accordingly, the second phase of the methodology decreases deformation of the sample.

A two-tailed, unequal variance, paired t-test was used to evaluate the differences in the average stretch ratios and angles. The results of the t-test are shown in Table 6 below, which shows that decreasing contact velocity decreases the stretch ratio and angular distortion in the sample. The decrease in impact velocity improves sample preparation as shown in FIG. 9.

TABLE 6

| | 2.5 | 5 | 10 | 30 |
|---|---|---|---|---|
| S.R. | | | | |
| 2.5 | | | | |
| 5 | 0.496 | | | |
| 10 | 0.222 | 0.513 | | |
| 30 | 0.021 | 0.027 | 0.042 | |
| Control | 0.00097 | 0.001192 | 0.002121 | 0.005009 |
| Theta | | | | |
| 2.5 | | | | |
| 5 | 0.029 | | | |
| 10 | 0.075 | 0.592 | | |
| 30 | 0.028 | 0.743 | 0.405 | |
| Control | 0.002909 | 0.003876 | 0.007256 | 0.006604 |
| Phi | | | | |
| 2.5 | | | | |
| 5 | 0.196 | | | |
| 10 | 0.024 | 0.303 | | |
| 30 | 0.031 | 0.086 | 0.188 | |
| Control | 0.013702 | 0.00256 | 0.000352 | 0.008066 |

For Table 6, statistical difference results (P-values) are provided between impact velocities and control for each of the measured deformation properties. A significant difference is indicated by P<0.05 (greyed boxes).

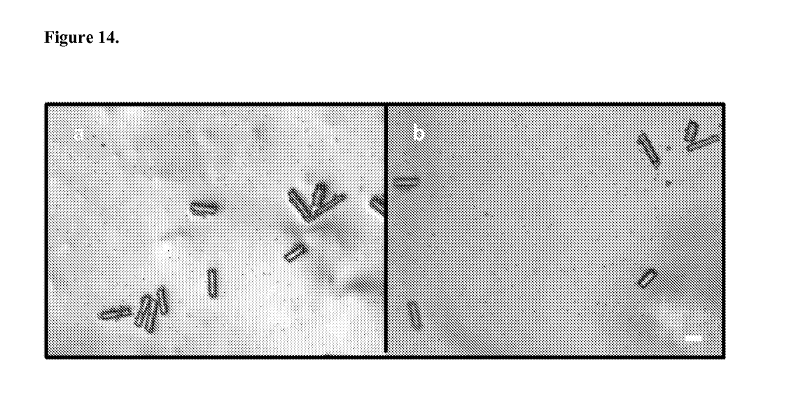

The stretch ratio is an absolute measure of deformation that is compared to impact velocity. Table 6 shows the results of the slow impact velocities (2.5, 5, and 10 cm/s) to that of a faster impact velocity (30 cm's). The faster impact velocity, common in other previous designs, is statistically different from the other, slower dual-phase impact velocities, which are still much faster than the methods and devices disclosed herein. By plotting the average stretch ratio versus impact velocity it is clear that stretch ratio, and therefore mechanical deformation, is indeed proportional to impact velocity (see FIG. 10a). FIG. 14 shows the deformation of a sample at 30 cm/s. Note the movement of glass rods in the sample after contacting the sample to the surface at 30 cm's.

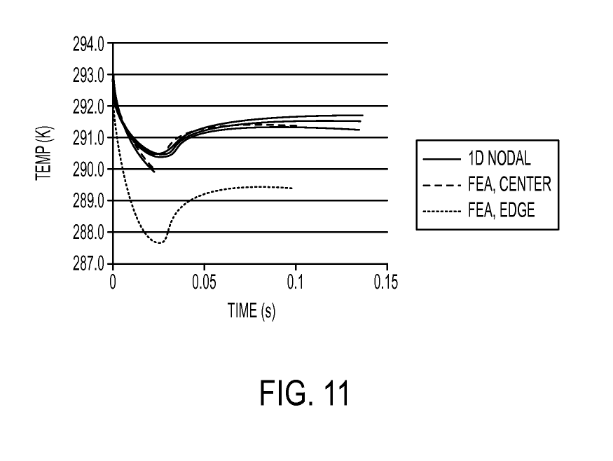

Temperature profiles at the center of the sample were generated from both the 1-D nodal and 3-d finite element analysis in ANSYS. The 3-D analysis also permitted estimation of the temperature of the outer edge of the sample. FIG. 11 shows temperature vs. time for the 0.025, 0.050, 0.100, and 4.5 m/s impact velocity cases, respectively, during the simulation of the sample's final approach through the vapor nitrogen. For the two phase velocity profiles, there is an initial cooling followed by reversal and warming of the sample prior to impact. For a single phase rapid velocity approach, which is used by most commercial systems, the sample is rapidly convectively cooled to a lower temperature before striking the cooled mirror. The 3-D analysis shows that the edge of the sample cools more than the centerline for the dual phase approach. Notably, all of the numerical analyses show little precooling for either method of approach.

### Strain Calculations

All strains were calculated as follows. The user entered the 3D coordinate data of the correlated pre- and post-frozen beads into the second set of MATLAB algorithms. The positions of the beads were converted from a Cartesian (X, Y, Z) to a spherical (r, theta, phi) coordinate system. The relative distance, rjk, from one bead, j, to every other bead, k, in each set was calculated. Theta, defined as the angle about the Z-axis formed by the projection of rjk on the XY plane and measured from the X-axis, and phi, defined as the vertical angle from the XY plane formed by rjk. For n beads, the number, m, of such relative distances is given by

m=n=(n−1)/2

For all m combinations, r, theta, and phi differences (Δ) between beads j and k for both sets were calculated. This gave an idea of how beads j and k changed relative to each other through impact with the cooled copper mirror. ΔTheta gave a measure of any twist motion resulting from the impact. It was assumed that no significant rotational effects parallel to the mirror surface should be induced. ΔPhi gave a measure of compression in the Z-direction. The difference between post- and pre-frozen r gives a change in relative distance between the two beads. Furthermore, the strain can also be calculated. The stretch ratio, SR, is defined as

$$S . R . = \frac{{r}_{jk}^{post}}{{r}_{jk}^{pre}}$$

In the above equation, the numerator was divided by the original relative distance between the two beads to give a percent stretch induced from the impact. All parameters were calculated for all m combinations of beads in the run, Average Δtheta, Δphi, and SR were also calculated for each run. All respective averages within a set were, in turn, averaged to get an overall quantifiable measure for each impact set.

The thermal analysis calculations were performed as follows. The Reynolds and Prandtl numbers were calculated using.

Re=VD/v (1)

and,

Pr=Cₚμ/k (2)

Where V, D, v, Cₚ, μ, and k are the flow velocity, disk diameter, kinematic viscosity, specific heat.
viscosity, and thermal conductivity, respectively, of nitrogen vapor. The average Nusselt number
used was,

N̅u̅=1.05Pr^{0.36}Re^{0.5} (3)

The Reynolds, Prandtl, and average Nusselt numbers could then be used to calculate the average convection coefficient,h

$$\overline{h} = \frac{k}{D} \overline{Nu} \qquad ( 4 )$$

The Biot number, Bi, could then be calculated using,

$$Bi = \frac{Δ x \overline{h}}{k} \qquad ( 5 )$$

A numerical solution was obtained using a nodal network with a space increment of Δx=0.005 min. As a worst-case scenario, it was assumed the sample cooled symmetrically about its midplane. Thus, the nodal network hadi=101 unknown nodal temperatures. The analysis was performed using the following finite-difference equations,

Tₒ^{p+1}=2Fo(Tᵢ₊₁^{p}+BiT_{∞})+(1−2Fo−2BiFo)Tₒ^{p} (6)

Tₜ^{p+1}=Fo(Tₜ₊₁^{p}+Tₜ₋₁^{p})+(1−2Fo)Tₜ^{p} (7)

T₁₀₁^{p+1}=2FoT₁₀₀^{p}+(1−2Fo)T₁₀₁^{p} (8)

These equations give the temperatures (Ti) for the surface node (i=0), internal node (0<i<101), and end node (i=101) temperatures, respectively, at the time step (p+1), based on the equivalent temperatures at the previous time step (p). In the equations, Fo and T∞ represent the Fourier number and ambient temperature, respectively. The time interval, Δt, was calculated using,

Δt=Fo(Δx)²/α (9)

where,

Fo≦½ (10)

is the one-dimensional stability criteria. Setting Fo=0.5, Δt becomes 87.23 μs. To be well within the stability limit, Δt=87.00 μs was selected, which corresponds to Fo=0.459. In the analysis, each property of the nitrogen vapor was calculated for the film temperature, Tf, as a function of the surface temperature using,

Tf=T0+T∞/2 (11)

### EQUIVALENTS

Those skilled in the art will recognize, or be able to ascertain, using no more than routine experimentation, numerous equivalents to the specific embodiments described specifically herein. Such equivalents are intended to be encompassed in the scope of the following claims.

We claim:

1. A method of attaching a sample to a surface, the method comprising contacting the sample to the surface at a contact velocity of 0.05 cm/s to 10 cm/s, wherein the sample is affixed to a first end of a positioner and wherein the sample freezes after contacting the surface.

2. The method of claim 1, wherein the positioner is normal to the surface.

3. The method of claim 1 further comprising actuating the positioner to a first velocity.

4. The method of claim 3 further comprising decelerating the positioner to the contact velocity from the first velocity.

5. The method of claim 3, wherein the first velocity is a maximum velocity of about 4.5 m/s.

6. The method of claim 3, wherein the positioner is continuously decelerated after the positioner reaches the first velocity.

7. The method of claim 3, wherein the positioner is movably attached to a guide and the positioner is decelerated upon reaching a first position on the guide.

8. A method of affixing a sample to a surface, the method comprising:
(a) attaching the sample to a first end of a positioner;
(b) accelerating the positioner to a first velocity toward the surface;
(c) decelerating the positioner to a contact velocity before the sample contacts the surface; and
(d) contacting the surface with the sample at the contact velocity, wherein the sample contacts the surface less than or equal to 0.3 seconds after the positioner is accelerated toward the surface.

9. The method of claim 8, wherein the first velocity is a maximum velocity of at least 1.0 m/s.

10. The method of claim 8, wherein the contact velocity is 0.05 cm/s.

11. The method of claim 8, wherein the positioner is normal to the surface.

12. The method of claim 8, wherein the positioner is movably attached to a guide.

13. The method of claim 8, wherein the sample is attached to a solid support that is affixed to the first end of the positioner.

14. A method of attaching a sample to a surface, the method comprising:
(a) affixing a solid support to a first end of a positioner movably attached to a guide such that the positioner is normal to a surface, and wherein the sample is attached to the solid support;
(b) actuating the positioner toward a first location on the guide, the positioner attaining a first velocity;
(c) decelerating the positioner subsequent to the positioner reaching the first location on the guide such that the positioner attains a contact velocity of 0.05 cm/s to 10 cm/s prior to the sample contacting the surface; and
(d) contacting the surface with the sample after the positioner as attained the contact velocity.

15. The method of any of claims 1, 8, or 14, wherein the surface comprises copper, steel, aluminum, gold, silver, sapphire, or diamond.

16. The method of any of claims 13 or 14, wherein the solid support comprises ceramic or metal.

17. The method of any of claims 1, 8, or 14, wherein the positioner is a linear motor actuator.

18. The method of any of claims 1, 8, or 14, wherein the positioner is magnetized.

19. The method of claim 14, wherein the positioner is removably attached to the guide.

20. The method of claim 14, wherein the first location on the guide defines a total distance from the sample to the surface.

21. The method of claim 20, wherein the total distance is divided into at least a first distance and a final distance from the sample to the surface.

22. The method of claim 21, wherein positioner travels the final distance from the sample at the first location to the surface in a total time of less than or equal to 0.1 seconds.

23. The method of claim 14 further comprising accelerating the positioner subsequent to the first end of the positioner reaching the location on the guide so that the positioner attains the first velocity after the first end of the positioner reaches the first location.

24. The method of claim 14 further comprising determining the time point that the sample will reach a second location on the guide based on the determination that the sample reached the first location, wherein the positioner is decelerated upon reaching the second location.

25. The method of claim 24, wherein the position is decelerated at the second location on the guide.

26. The method of claim 24, wherein the position of the sample is determined by a sensor.

27. The method of claim 26, wherein the sensor comprises a sheet laser.

28. The method of claim 14, wherein the sample is a tissue.

29. The method of claim 14 further comprising determining the first velocity to which the positioner will be accelerated.

30. The method of claim 29 further comprising determining the contact velocity to which the positioner will be decelerated.

31. The method of claim 30 further comprising storing the determined first velocity and determined contact velocity in a memory.

32. The method of any of claims 13 or 14, wherein the solid support is attached to a magnetic mount.

33. The method of claim 32, wherein the magnetic mount is further attached to the first end of the positioner.

34. The hod of any of claims 4 or 14, wherein the first velocity is at least 1.0 m/s.

35. The method of claim 34, wherein the first velocity is about 4.5 m/s.

36. The method of any of claims 1, 8, or 14, wherein the contact velocity is 0.1 to 10.0 cm/s.

37. The method of any of claims 1, 8, or 14, wherein the contact velocity is 5.0 to 7.5 cm/s.

38. The method of any of claims 1, 8, or 14, wherein the contact velocity is 2.5 to 5.0 cm/s.

39. The method of any of claims 1, 8, or 14, wherein the contact velocity is about 2.5 cm/s.

40. The method of any of claims 3, 8, or 14, wherein the positioner is accelerated at 100 m/s² to attain the first velocity.

41. The method of any of claims 3, 8, or 14, wherein the positioner is accelerated at greater than or equal to 100 m/s² to attain the first velocity.

42. The method of any of claims 3, 8, or 14, wherein the positioner is decelerated at greater than or equal to 100 m/s² to attain the contact velocity after reaching a location on the guide, wherein the location on the guide is either the first location or a different location.

43. The method of any of claims 3, 8, or 14, wherein the positioner is decelerated at greater than or equal to 50 m/s² to attain the contact velocity after reaching a location on the guide, wherein the location on the guide is either the first location or a different location.

44. The method of any of claims 3, 8, or 14, wherein the positioner is decelerated at greater than or equal to 20 m/s² to attain the contact velocity after reaching a location on the guide, wherein the location on the guide is either the first location or a different location.

45. The method of claim 42, wherein the positioner is decelerated at 150 m/s² after reaching the location on the guide to attain the contact velocity.

46. The method of any of claims 3, 8, or 14 further comprising providing a computer having a memory, the memory providing code to at least one processor such that the processor controls the positioner to attain the first velocity and the contact velocity based on a determined first and contact velocity stored in the memory.

47. The method of any of claims 8 or 14, wherein the sample freezes after contacting the surface.
